(19) United States
(12) Patent Application Publication
(10) Pub. No.: US 2026/0228578 A1
(43) Pub. Date: Aug. 6, 2026

(54) PREDICTION MODEL EVALUATION APPARATUS, METHOD, AND PROGRAM

(71) Applicant: NTT, Inc., Tokyo (JP)

(72) Inventors: Tomu TOMINAGA, Musashino-shi (JP); Shuhei YAMAMOTO, Musashino-shi (JP); Takeshi KURASHIMA, Musashino-shi (JP)

(73) Assignee: NTT, Inc., Tokyo (JP)

(21) Appl. No.: 19/127,749

(22) PCT Filed: Nov. 14, 2022
(86) PCT No.: PCT/JP2022/042253

§ 371 Date: May 7, 2025

(51) Int. Cl. G06N 5/045

(52) U.S. Cl. CPC G06N 5/045

(57) ABSTRACT

A prediction model evaluation apparatus according to one embodiment receives an input of a new condition for searching for a causal relationship between a variable to be predicted and an explanatory variable significantly correlated with the variable to be predicted and an input of a new condition for generating a prediction model, newly searches for a causal relationship between the variable to be predicted and the explanatory variable significantly correlated with the variable to be predicted based on the new condition for searching, newly obtains an explanatory variable having a parent relationship with the variable to be predicted based on the newly searched causal relationship, newly generates a prediction model for predicting the newly obtained explanatory variable having a parent relationship with the variable to be predicted based on the new condition for generating, and newly calculates the prediction value by using the newly generated prediction model.

### TECHNICAL FIELD

Embodiments of the present invention relate to a prediction model evaluation apparatus, a method, and a program.

### BACKGROUND ART

In fields related to physical, economic, or social health conditions (lifespan) of human beings, such as healthcare, finance, or education, it is important for a system that intervenes in an individual's decision-making to explain to a user the circumstances and reasons for the intervention with respect to a target person and to convince the user.

When realizing this, it is desired that, in order to know a user and an action that are intervention targets, the system have the ability to predict the user's action well in advance from given information. In this respect, many studies have been carried out to develop a technique for constructing a highly accurate prediction model and specifying a feature value with high prediction power (see, for example, Non Patent Literature 1 and Non Patent Literature 2). Here, the degree of prediction power indicates the degree of contribution to minimizing a prediction error. That is, the degree of prediction power does not necessarily indicate a causal relationship.

In addition, it is desirable that the system be able to grasp the cause of a result, not only to minimize a prediction error. In the related art, generalization and robustness of a prediction model have been secured (see, for example, Non Patent Literature 4 and Non Patent Literature 5) by specifying a causal relationship between pieces of data using a statistical causal search method and by selecting variables based on the causal relationship (see, for example, Non Patent Literature 3).

### CITATION LIST

### Non Patent Literature

Non Patent Literature 1: Fisher, Aaron, Cynthia Rudin, and Francesca Dominici. “All Models are Wrong, but Many are Useful: Learning a Variable's Importance by Studying an Entire Class of Prediction Models Simultaneously.” J. Mach. Learn. Res. 20.177 (2019): 1-81.
Non Patent Literature 2: Lundberg, Scott M., and Su—In Lee. “A unified approach to interpreting model predictions.” Advances in neural information processing systems 30 (2017).
Non Patent Literature 3: Yu, Kui, Lin Liu, and Jiuyong Li. “A unified view of causal and non-causal feature selection.” ACM Transactions on Knowledge Discovery from Data (TKDD) 15.4 (2021): 1-46.
Non Patent Literature 4: Li, Jundong, et al. “Feature selection: A data perspective.” ACM computing surveys (CSUR) 50.6 (2017): 1-45.
Non Patent Literature 5: Susan Athey. 2017. Beyond prediction: Using big data for policy problems. Science 355, 6324 (2017), 483-485.

### SUMMARY OF INVENTION

### Technical Problem

In the related art, a certain variable group that is a direct cause for another variable is specified in given data, and these are used as predictive variables, thereby making it possible to increase prediction power as a machine learning model while supporting these predictive variables as a statistical a cause system, but there are still the following problems.

First, although a causal relationship between variables is guaranteed from a statistical viewpoint by using a statistical causal search method, it is not evaluated whether the causal relationship can be understood by a human being.

Specifically, a specified causal relationship and the structure and function of a machine learning model have to be evaluated by a person (hereinafter, an operator) who operates the model consisting of feature values selected based on the specified causal relationship by the statistical causal search method and a person (hereinafter, a recipient) who receives information presentation from the model.

This is because the degree of interpretability of the model is determined by whether the operator or the recipient of the model can understand the behavior of the model, and because it is considered that the higher the degree of interpretability of the model is, the more useful it is for the decision making of an individual user.

Furthermore, because of the above-described problems, it is not possible to grasp setting conditions for a system which are preferable or not preferable for the operator or the recipient. By using the evaluation of the operator or the recipient as feedback to the system, it is expected that a system condition can be updated such that information presentation which is more easily interpreted by the operator or the recipient can be realized. However, currently, evaluation from an operator or a recipient is not performed on a machine learning model, which consists of feature values selected through feature value selection based on a statistical causal search method, or a system equipped with the model, and thus this evaluation cannot be used for realizing information presentation with higher interpretability.

The present invention has been made in view of the above-described circumstances, and an object thereof is to provide a prediction model evaluation apparatus, a method, and a program which are capable of constructing a prediction model for a variable to be predicted that is easily understood by a user.

### Solution to Problem

A prediction model evaluation apparatus according to an aspect of the present invention includes a search unit configured to search for a causal relationship between observation data of a variable to be predicted and observation data of an explanatory variable significantly correlated with the variable to be predicted, and to obtain an explanatory variable having a parent relationship with the variable to be predicted based on the searched causal relationship, a generation unit configured to generate a prediction model for predicting the variable to be predicted from the explanatory variable, a prediction unit configured to calculate a prediction value significantly correlated with input data using the prediction model generated by the generation unit, and an input unit configured to receive an input of a new condition for searching for the causal relationship and a new condition for generating the prediction model by the generation unit, in which the search unit newly searches for a causal relationship between the variable to be predicted and the explanatory variable significantly correlated with the variable to be predicted based on the new condition for searching, and newly obtains an explanatory variable having a parent relationship with the variable to be predicted based on the newly searched causal relationship, the generation unit newly generates a prediction model for predicting the explanatory variable, which is newly obtained by the search unit, having a parent relationship with the variable to be predicted based on the new condition for generating, and the prediction unit newly calculates the prediction value by using the prediction model newly generated by the generation unit.

A prediction model evaluation method according to an aspect of the present invention is a method performed by a prediction model evaluation apparatus, the method including searching for a causal relationship between observation data of a variable to be predicted and observation data of an explanatory variable significantly correlated with the variable to be predicted, and obtaining an explanatory variable having a parent relationship with the variable to be predicted based on the searched causal relationship, generating a prediction model for predicting the variable to be predicted from the explanatory variable, calculating a prediction value significantly correlated with input data using the generated prediction model, receiving an input of a new condition for searching for the causal relationship and a new condition for generating the prediction model, newly searching for a causal relationship between the variable to be predicted and the explanatory variable significantly correlated with the variable to be predicted based on the new condition for searching, newly obtaining an explanatory variable having a parent relationship with the variable to be predicted based on the newly searched causal relationship, newly generating a prediction model for predicting the newly obtained explanatory variable having a parent relationship with the variable to be predicted based on the new condition for generating, and newly calculating the prediction value by using the newly generated prediction model.

### Advantageous Effects of Invention

According to the present invention, it is possible to construct a prediction model of a variable to be predicted that is easily understood by a user.

### BRIEF DESCRIPTION OF DRAWINGS

FIG. 1 is a diagram showing an application example of a prediction model evaluation apparatus according to an embodiment of the present invention.

FIG. 2A is a diagram showing an example of a flow of information in processing during learning.

FIG. 2B is a flowchart showing an example of processing content during learning.

FIG. 3A is a diagram showing an example of a flow of information in processing during explanation.

FIG. 3B is a flowchart showing an example of processing content during explanation.

FIG. 3C is a diagram showing an example of presentation content in processing during explanation.

FIG. 4A is a diagram showing an example of a flow of information in processing during evaluation.

FIG. 4B is a flowchart showing an example of processing content during evaluation.

FIG. 4C is a flowchart showing an example of processing content during evaluation.

FIG. 4D is a diagram showing an example of presentation content in processing during evaluation.

FIG. 5A is a diagram showing an example of a flow of information in processing during updating.

FIG. 5B is a flowchart showing an example of processing content during updating.

FIG. 6 is a block diagram showing an example of a hardware configuration of a prediction model evaluation apparatus according to an embodiment of the present invention.

### DESCRIPTION OF EMBODIMENTS

An embodiment according to the present invention will be described below with reference to the drawings.

In order to solve the above-described problems of the related art, this embodiment provides a system in which a mechanical learning model, which is a prediction model that specifies a direct cause system for a certain objective variable based on a causal relationship between pieces of observation data extracted from given observation data by a statistical causal search method and adopts the direct cause system as feature data, is mounted and which explains a causal relationship between pieces of data and an action of the model. The system is given a function of making a user interpret a causal relationship between pieces of observation data by receiving evaluation from an operator or a person who receives an explanation of the system and using the evaluation as feedback.

Thereby, it is possible to provide a causal feature value prediction model evaluation apparatus capable of evaluating the interpretability of a machine learning model by a human being and grasping system design conditions for realizing information presentation which is easier to interpret for an operator or a recipient.

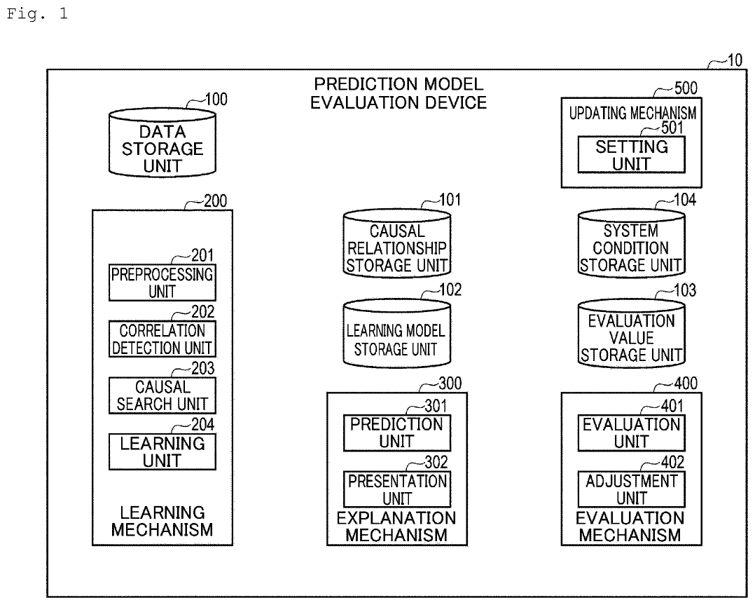

FIG. 1 is a diagram showing a configuration example of a causal feature value prediction model evaluation apparatus according to an embodiment of the present invention.

As shown in FIG. 1, the apparatus includes five storage units and four mechanisms. Specifically, the apparatus includes a data storage unit 100, a causal relationship storage unit 101, a learning model storage unit 102, an evaluation value storage unit 103, a system condition storage unit 104, a learning mechanism 200, an explanation mechanism 300, an evaluation mechanism 400, and an updating mechanism 500.

The learning mechanism 200 includes a preprocessing unit 201, a correlation detection unit 202, a causal search unit 203, and a learning unit (model generation unit) 204. The explanation mechanism 300 includes a prediction unit 301 and a presentation unit 302. The evaluation mechanism 400 includes an evaluation unit 401 and an adjustment unit 402. The updating mechanism 500 includes a setting unit 501.

The data storage unit 100 stores explanatory variables of observation data and an objective variable to be predicted (hereinafter referred to as a variable to be predicted).

The causal relationship storage unit 101 stores a causal graph specified by the causal search unit 203. Here, the causal graph is a weighted directed graph, and consists of a node set when each explanatory variable and an objective variable are defined as nodes and an adjacent matrix related to the weight of an edge connecting the nodes.

The learning model storage unit 102 stores a model structure of a machine learning model learned by the learning unit 204 and learned parameters.

The evaluation value storage unit 103 stores evaluation values for the system which are input by the evaluation unit 401 by an operator or a recipient (hereinafter, collectively referred to as a user). Items of the evaluation values and a measurement method will be described later.

The system condition storage unit 104 stores a system condition input by the user through the adjustment unit 402 and the evaluation values for the system input through the evaluation unit 401 in association with each other. Details of the system condition will be described later.

Next, processing of a causal feature value prediction model evaluation apparatus according to this embodiment will be described. A series of processing is divided into four stages, that is, learning, explanation, evaluation, and updating.

### <Overview of Processing>

### (1) Processing Procedure During Learning

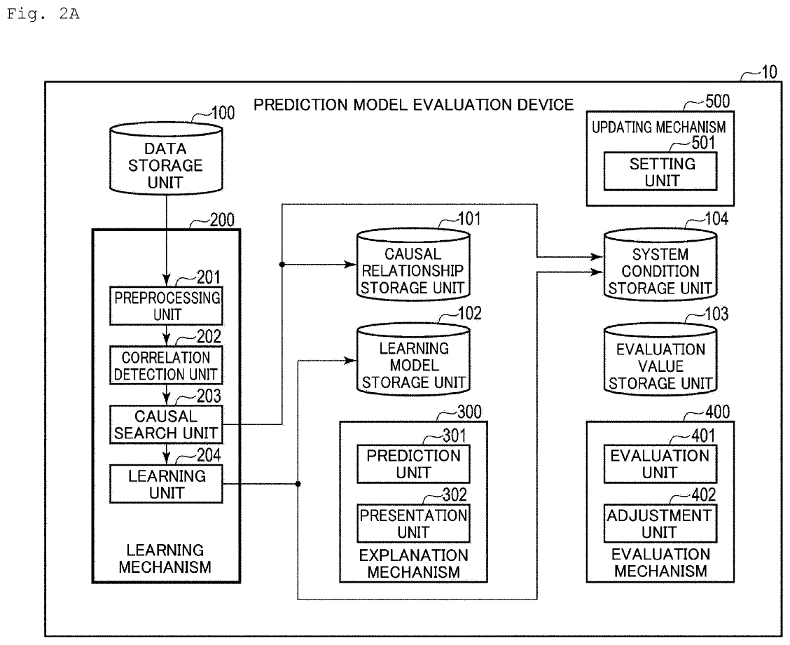

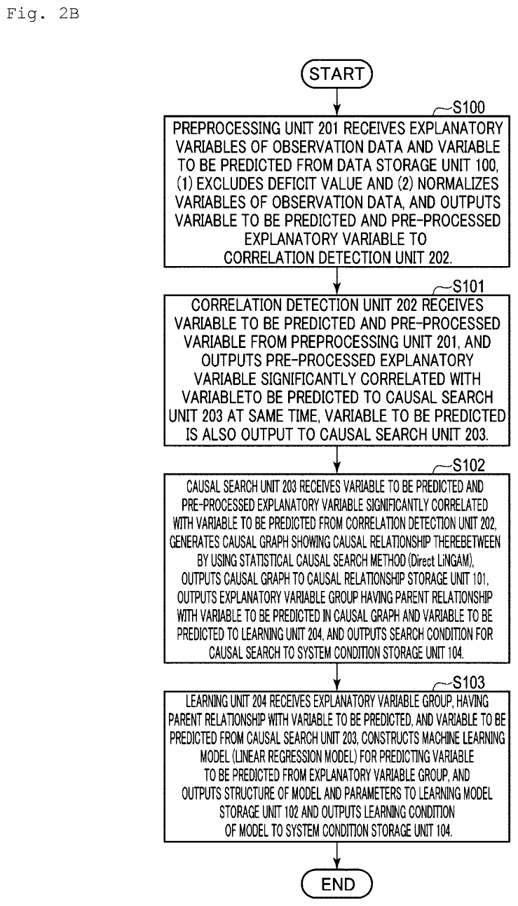

FIG. 2A is a diagram showing an example of a flow of information in processing during learning. FIG. 2B is a flowchart showing an example of processing content during learning. A processing procedure is as follows. Specific processing steps will be described later.

S100: The preprocessing unit 201 receives explanatory variables of observation data and a variable to be predicted from the data storage unit 100, performs (1) exclusion of a deficit value and (2) normalization of the explanatory variables of the observation data as preprocessing, and outputs the variable to be predicted and the pre-processed explanatory variables to the correlation detection unit 202.

S101: The correlation detection unit 202 receives the variable to be predicted and the pre-processed explanatory variables output from the preprocessing unit 201 in S100, detects a pre-processed explanatory variable significantly correlated with the variable to be predicted, and outputs the detected pre-processed explanatory variable to the causal search unit 203. At the same time, the correlation detection unit 202 also outputs the received variable to be predicted to the causal search unit 203.

S102: The causal search unit 203 receives the variable to be predicted and the pre-processed explanatory variable significantly correlated with the variable, which are output from the correlation detection unit 202 in S101, and generates a causal graph using a statistical causal search method as a causal relationship therebetween. The causal search unit 203 outputs the generated causal graph to the causal relationship storage unit 101, outputs an explanatory variable group having a parent relationship with the variable to be predicted in the causal graph and the variable to be predicted to the learning unit 204, and outputs a search condition of causal search to the system condition storage unit 104.

S103: The learning unit 204 receives the explanatory variable group having a parent relationship with the variable to be predicted, and the variable to be predicted, which are output in S102, from the causal search unit 203, constructs a machine learning model for predicting the variable to be predicted from the explanatory variable group, outputs a model structure which is the structure of the machine learning model and learned parameters of the machine learning model to the learning model storage unit 102, and outputs a learning condition of the machine learning model to the system condition storage unit 104.

### (2) Processing Procedure During Explanation

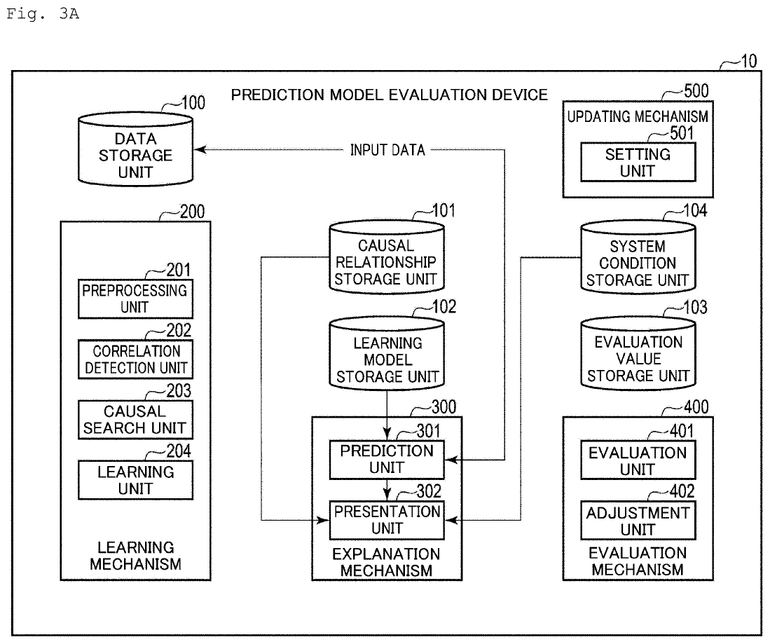

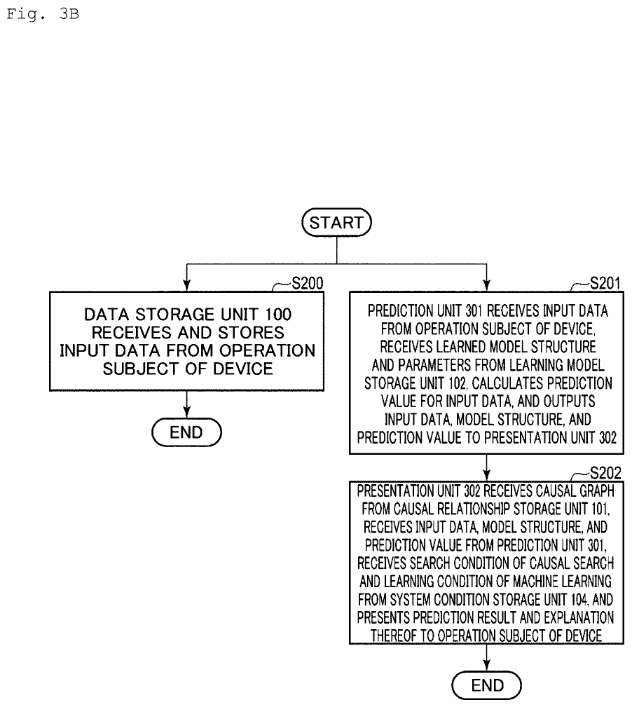

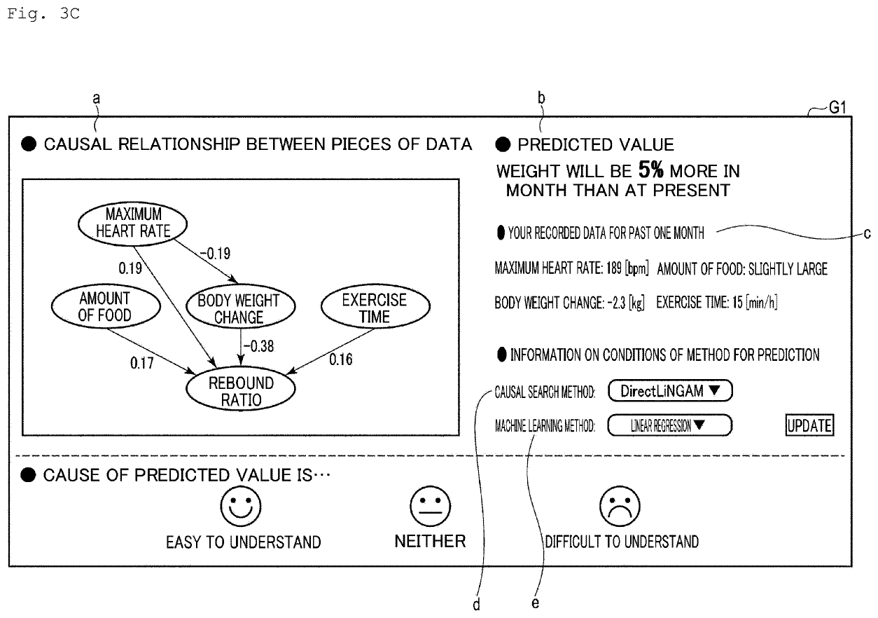

FIG. 3A is a diagram showing an example of a flow of information in processing during explanation. FIG. 3B is a flowchart showing an example of processing content during explanation. FIG. 3C is a diagram showing an example of presentation content in processing during explanation. A processing procedure is as follows. Specific processing steps will be described later.

S200: The data storage unit 100 receives input data from an operation subject of the apparatus and stores the input data.

S201: The prediction unit 301 receives input data from an operation subject of the apparatus, receives a learned model structure and parameters from the learning model storage unit 102, calculates a prediction value for the received input data, and outputs the input data, the model structure, and the prediction value to the presentation unit 302.

S202: The presentation unit 302 receives a causal graph from the causal relationship storage unit 101, receives the input data, the model structure, and the prediction value, which are output in S201, from the prediction unit 301, receives a search condition of causal search and a learning condition of machine learning from the system condition storage unit 104, and presents the operation subject of the apparatus the received (1) the causal graph (sign “a” in FIG. 3C), (2) the prediction value (sign “b” in FIG. 3C), (3) the input data (sign “c” in FIG. 3C), (4) the search condition (drop-down selection formula) (sign “d” in FIG. 3C), and (5) the model structure and the learning condition (drop-down selection formula) (sign “e” in FIG. 3C) as a presentation screen G1 shown in FIG. 3C, for example.

### (3) Processing Procedure During Evaluation

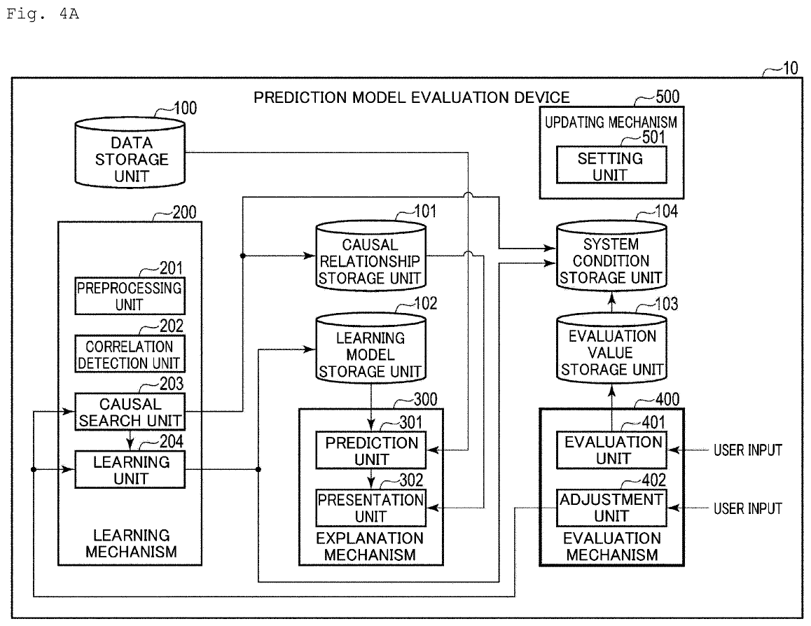

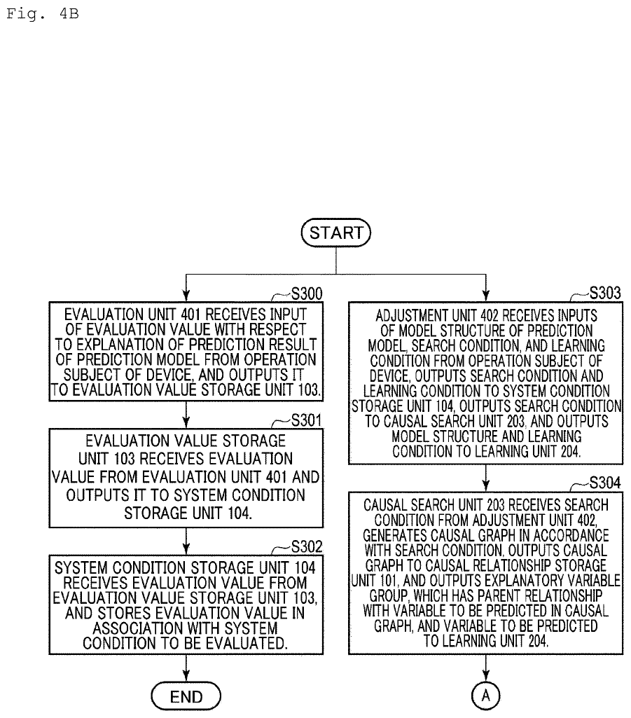

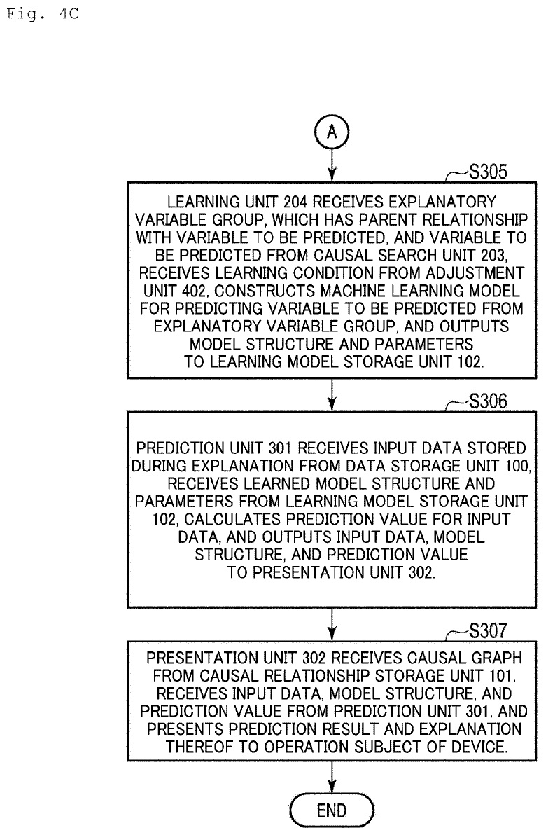

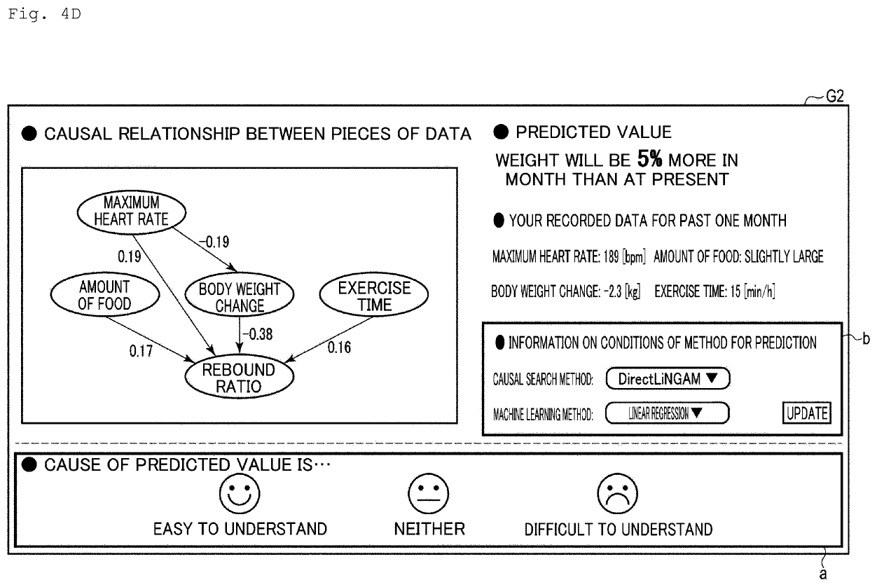

FIG. 4A is a diagram showing an example of a flow of information in processing during evaluation. FIGS. 4B and 4C are flowcharts showing an example of processing contents during evaluation. FIG. 4D is a diagram showing an example of presentation content in processing during evaluation. A processing procedure is as follows. Specific processing steps will be described later.

S300: The evaluation unit 401 receives an input of an evaluation value for explanation of a prediction result of a prediction model from an operation subject of the apparatus, and outputs it to the evaluation value storage unit 103.

S301: The evaluation value storage unit 103 receives the evaluation value output from the evaluation unit 401 in S300 and outputs it to the system condition storage unit 104.

S302: The system condition storage unit 104 receives the evaluation value output in S301 from the evaluation value storage unit 103, and stores the evaluation value and a system condition to be evaluated in association with each other.

S303: The adjustment unit 402 receives inputs of a model structure, a search condition, and a learning condition of the prediction model from the operation subject of the apparatus, outputs the search condition and the learning condition to the system condition storage unit 104, outputs the search condition to the causal search unit 203, and outputs the model structure and the learning condition to the learning unit 204.

S304: The causal search unit 203 receives the search condition output in S303 from the adjustment unit 402, generates a causal graph in accordance with the search condition, outputs the generated causal graph to the causal relationship storage unit 101, and outputs an explanatory variable group having a parent relationship with a variable to be predicted in the generated causal graph and a variable to be predicted to the learning unit 204.

S305: The learning unit 204 receives the explanatory variable group having a parent relationship with the variable to be predicted and the variable to be predicted, which are output in S304, from the causal search unit 203, receives the learning condition output in S303 from the adjustment unit 402, constructs a machine learning model for predicting the variable to be predicted from the explanatory variable group, and outputs the learning model, the model structure, and parameters to the learning model storage unit 102.

S306: The prediction unit 301 receives input data stored during explanation from the data storage unit 100, receives the learned model structure and parameters from the learning model storage unit 102, calculates a prediction value for the input data, and outputs the input data, the model structure, and the prediction value to the presentation unit 302.

S307: The presentation unit 302 receives the causal graph from the causal relationship storage unit 101, receives the input data, the model structure, and the prediction value from the prediction unit 301, and presents a prediction result and the explanation thereof to an operation subject of the apparatus. During evaluation, an interface (sign “a” in FIG. 4D) in the evaluation unit 401 and an interface (sign “b” in FIG. 4D) in the adjustment unit 402 are displayed on a screen G2 for presentation shown in FIG. 4D.

### (4) Processing Procedure During Updating

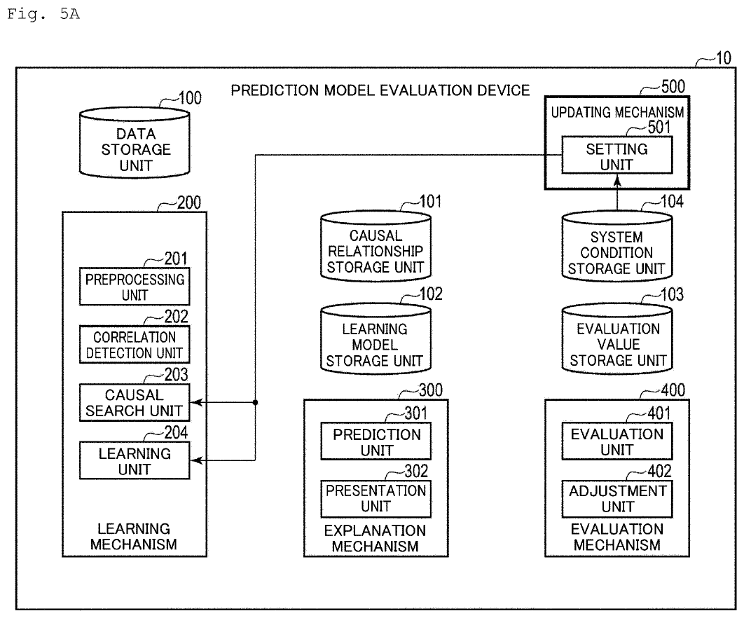

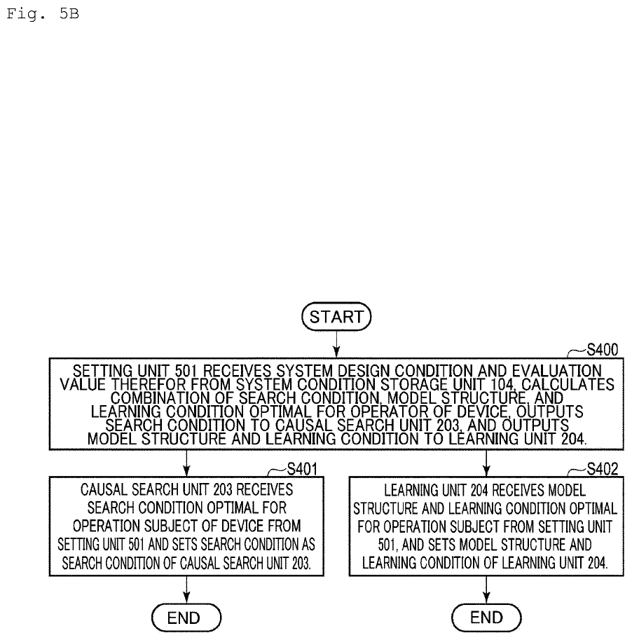

FIG. 5A is a diagram showing an example of a flow of information in processing during updating. FIG. 5B is a flowchart showing an example of processing contents during updating. A processing procedure is as follows. Specific processing steps will be described later.

S400: The setting unit 501 receives a system design condition and an evaluation value therefor from the system condition storage unit 104, calculates a combination of a search condition, a model structure, and a learning condition which are optimal for an operator of the apparatus, outputs the search condition to the causal search unit 203, and outputs the model structure and the learning condition to the learning unit 204.

S401: The causal search unit 203 receives the search condition which is output in S400 from the setting unit 501 and is optimal for the operation subject of the apparatus, and sets the search condition as a search condition of the causal search unit 203.

S402: The learning unit 204 receives the model structure and the learning condition optimal for the operation subject, which are output in S400 from the setting unit 501, and sets them as a model structure and a search condition of the learning unit 204.

### <Details of Processing>

Steps of specific processing in each processing procedure will be described below. Hereinafter, the number of samples of target data is assumed to be n, and the number of explanatory variables is assumed to be m. Further, a data value of a certain variable j∈{1, . . . , m} of a certain sample i∈{1, . . . , n} is assumed to be a data value xᵢⱼ of an explanatory variable. Further, a data value of an objective variable of a certain sample of i∈{1, . . . , n} is assumed to be yᵢ. The data value xᵢⱼ and the data value yᵢ are stored in the data storage unit 100.

### (1) Specific Processing Contents During Learning

A step of processing in the preprocessing unit 201 (S100 in FIG. 2B) is described. The preprocessing unit 201 receives the data value xᵢⱼ of the explanatory variable and the data value yᵢ of the objective variable from the data storage unit 100, and performs necessary preprocessing on the data values xᵢⱼ and yᵢ in order to execute correlation analysis in the correlation detection unit 202 included in the learning mechanism 200 and causal search included in the causal search unit 203. Here, exclusion of a deficit value is first performed, and then normalization of an explanatory variable is performed.

Next, the above-described exclusion of a deficit value will be described. In the exclusion of the deficit value, the preprocessing unit 201 configures a data sample set D from the data values xᵢⱼ and yᵢ received from the data storage unit 100 in accordance with the following Formulas (1) and (2).

$${d}_{i} = \{ {y}_{i} , {x}_{i 1} , … , {x}_{im} \} \qquad Formula ( 1 )$$

$$D = \{ {d}_{i} \vert i = 1 , … , n \} \qquad Formula ( 2 )$$

Here, the preprocessing unit 201 performs processing on all i in accordance with the following Formula (3), thereby excluding the data sample di including the deficit value from the data sample set D. Here, the data value indicating the deficit value is denoted by NA.

$$if NA ∈ {d}_{i} then D \to D \backslash \{ {d}_{i} \} \qquad Formula ( 3 )$$

The data sample set obtained by the above-described step is defined as D*. Here, for simplicity, the following step will be described assuming that D*=D.

Next, normalization of the above-described explanatory variable will be described. In the normalization, the preprocessing unit 201 normalizes a variable j for an explanatory variable xᵢⱼ (∈dᵢ)∈D* included in the above-described data sample set D*. Here, a variable zᵢⱼ is obtained by standardizing the data value xᵢⱼ of the explanatory variable so that a mean and a variance for the variable j are 0 and 1, respectively, in accordance with the steps shown in the following Formulas (4), (5-1), and (5-2).

$$\begin{matrix}[ Math . 1 ] & \\ {z}_{ij} = \frac{{x}_{ij} - {μ}_{j}}{{σ}_{j}} & Formula ( 4 )\end{matrix}$$

$${μ}_{j} = \frac{{\sum }_{i} {x}_{ij}}{n} \qquad Formula ( 5 - 1 )$$

$${σ}_{j} = \sqrt{\frac{{\sum }_{i} {( {x}_{ij} - {μ}_{j} )}^{2}}{n}} \qquad Formula ( 5 - 2 )$$

The preprocessing unit 201 outputs the data value yᵢ∈D* of the objective variable and the standardized variable zᵢⱼ to the correlation detection unit 202.

Next, a step (S101 in FIG. 2B) of processing in the correlation detection unit 202 will be described. The correlation detection unit 202 receives the data value yᵢ of the objective variable and the above-mentioned standardized variable zᵢⱼ from the preprocessing unit 201, and specifies a variable zⱼ=(zᵢⱼ, . . . , zₙⱼ)^{T} which is correlated with an objective variable y=(y₁, . . . , yₙ)^{T}. A correlation coefficient γᵢ with the variable zⱼ which is correlated with the objective variable y is obtained by the following Formula (6).

$$\begin{matrix}[ Math . 2 ] & \\ {γ}_{j} = \frac{Cov ( y , {z}_{j} )}{\sqrt{Var ( y ) Var ( {z}_{j} )}} & Formula ( 6 )\end{matrix}$$

Here, Cov in Formula (6) is a covariance of two given variables, and Var in Formula (6) is a function used to calculate a variance of a given variable. When the significance level of the correlation analysis is a and the significance probability of the correlation coefficient obtained by Formula (6) is pⱼ, a set Z* of variables that satisfies pⱼ<α is defined as shown in the following Formula (7). In general, α is set to any one of 0.05, 0.01, or 0.001, but the operation subject of the apparatus may arbitrarily set the significance level α.

$${Z}^{*} = \{ {z}_{j} \vert {p}_{j} < α , j ∈ \{ 1 , … , m \} \} \qquad Formula ( 7 )$$

Here, for simplicity, the following step will be described assuming that Z*=Z when Z={z₁, . . . , zₘ}.

The correlation detection unit 202 outputs the objective variable y and the set of variables Z* to the causal search unit 203.

Next, a step of processing in the causal search unit 203 (S102 in FIG. 2B) will be described. The causal search unit 203 searches and estimates a causal relationship between the variables by using the objective variable y and the set of variables Z* received from the correlation detection unit 202. Here, a method referred to as a liner non-Gaussian acyclic model (LINGAM) is used. However, means for performing the causal search is not limited as long as a causal relationship can be searched and statistical reliability can be evaluated. The LiNGAM is one of statistical causal search methods, and a causal relationship between variables is uniquely identified by setting the following conditions (1) to (4).
(1) A condition on a function system: A relationship between variables is linear
(2) A condition on an error distribution: Error distributions of variables are non-Gaussian processes and are independent of each other
(3) A condition on circularity: A causal relationship between variables is acyclic
(4) A condition on hidden common cause: There is no hidden common cause

Under these conditions, the causal search unit 203 assumes a model in accordance with the following Formula (8) using a LiNGAM.

$$\begin{matrix}[ Math . 3 ] & \\ {v}_{i} = {\sum }_{j \neq i}^{} {b}_{ij} {v}_{j} + {e}_{i} ( i = 0 , … , m ) & Formula ( 8 )\end{matrix}$$

In Formula (8), each variable is defined as vᵢ=(y, z₁, . . . , zₘ), a coefficient is defined as bᵢⱼ, and an error variable is defined as eᵢ. The matrix notation can be written as in the following Formula (9).

$$\begin{matrix}[ Math . 4 ] & \\ v = Bv + e & Formula ( 9 )\end{matrix}$$

In the causal search using the LiNGAM, the causal search unit 203 first calculates values of respective elements (the order and the scales of which are not identifiable) of a coefficient matrix, then estimates a causal order between variables, and finally estimates a coefficient matrix shown in [Math. 5].

$$B \qquad [ Math . 5 ]$$

The causal order refers to an order in which, when the variables are rearranged in accordance with the order, a later variable will not be the cause (ancestor in graph expression) of an earlier variable. Here, the causal order of the variable vᵢ is assumed to be k(i). For example, when k(3)=2, the causal order of a variable v₃ is interpreted as being second.

Next, the calculation of the values of the respective elements of the coefficient matrix will be described.

$$v = {( I - B )}^{- 1} e = Ae \qquad [ Math . 6 ]$$

From the above Formula (9), the formula shown in [Math. 6] is obtained. However, the following relationship is established.

$$A = {( I - B )}^{- 1} \qquad [ Math . 7 ]$$

$$e \qquad [ Math . 8 ]$$

Here, since the elements shown in [Math. 8] of the above formula are independent of each other, an inverse matrix shown in [Math. 10] of the matrix shown in [Math. 9] can be obtained as a restored matrix by independent component analysis.

$$A \qquad [ Math . 9 ]$$

$$W ( = {A}^{- 1} ) \qquad [ Math . 10 ]$$

A coefficient matrix estimated through this step is shown in [Math. 11], and the formula shown in [Math. 12] is obtained.

$$\hat{B} \qquad [ Math . 11 ]$$

$$W = I - \hat{B} ⇔ \hat{B} = I - W \qquad [ Math . 12 ]$$

Since this value is obtained by independent component analysis, the order and scales of the matrices are not identifiable. Consequently, the causal search unit 203 corrects the order of the matrices by estimating a causal order to be described below.

Next, a method of estimating the causal order will be described. First, when both sides of the above Formula (9) are multiplied by a substitution matrix shown in [Math. 13] from the left, the following Formula (10) is obtained.

$$[ Math . 13 ]$$

$$\ddot{P}$$

$$[ Math . 14 ]$$

$$\ddot{P} v = \ddot{P} Bv + \ddot{P} e \qquad Formula ( 10 )$$

Considering the property that a substitution matrix is an orthogonal matrix, [Math. 15] is established, and thus, when this is substituted for a first term of a right side in Formula (10), the following Formula (11) is obtained.

$$[ Math . 15 ]$$

$${\ddot{P}}^{T} \ddot{P} = I$$

$$[ Math . 16 ]$$

$$\ddot{P} v = \ddot{P} B {\ddot{P}}^{T} \ddot{P} v + \ddot{P} e = ( \ddot{P} B {\ddot{P}}^{T} ) \ddot{P} v + \ddot{P} e \qquad Formula ( 11 )$$

This can be regarded as a LiNGAM model of a variable vector shown in [Math. 18] with the order of elements replaced by a substitution matrix shown in [Math. 17].

$$[ Math . 17 ]$$

$$\ddot{P}$$

$$[ Math . 18 ]$$

$$\ddot{P} v$$

At this time, the coefficient matrix is as shown in [Math. 19].

$$[ Math . 19 ]$$

$$\ddot{P} B {\ddot{P}}^{T}$$

When a coefficient matrix shown in [Math. 20] is configured in the LiNGAM model in accordance with a causal order, a coefficient matrix shown in [Math. 21] has a property of being close to a strictly lower triangular matrix.

$$[ Math . 20 ]$$

$$B$$

$$[ Math . 21 ]$$

$$B$$

By using it, the causal search unit 203 searches for a matrix shown in [Math. 23] such that a matrix shown in [Math. 22] is a lower triangular matrix.

$$[ Math . 22 ]$$

$$\ddot{P} B {\ddot{P}}^{T}$$

$$[ Math . 23 ]$$

$$\ddot{P}$$

$$[ Math . 24 ]$$

$$\ddot{P} B {\ddot{P}}^{T}$$

Whether a matrix shown in [Math. 24] is close to a strictly lower triangular matrix can be measured by the sum of squares of an upper triangular component and a diagonal component. Thus, the causal search unit 203 solves an optimization problem represented by the following Formula (12) to calculate a matrix shown in [Math. 26] such that a matrix shown in [Math. 25] is a lower triangular matrix.

$$[ Math . 25 ]$$

$$\ddot{P} B {\ddot{P}}^{T}$$

$$[ Math . 26 ]$$

$$\ddot{P}$$

Here, the causal search unit 203 substitutes a matrix shown in [Math. 27] with a matrix shown in [Math. 28].

$$[ Math . 27 ]$$

$$B$$

$$[ Math . 28 ]$$

$$\hat{B}$$

$$[ Math . 29 ]$$

$$\ddot{P} = {arg min}_{\ddot{P}} {\sum }_{i \leq j} {( \ddot{P} B {\ddot{P}}^{T} )}_{ij}^{2} \to {arg min}_{\ddot{P}} {\sum }_{i \leq j} {( \ddot{P} \hat{B} {\ddot{P}}^{T} )}_{ij}^{2} \qquad Formula ( 12 )$$

Thereby, the causal search unit 203 obtains a causal order.

$$[ Math . 30 ]$$

$${( \ddot{P} )}_{ij} = 1$$

For example, the above formula shown in [Math. 30] indicates k(i)=j.

Next, a method of estimating the above-described coefficient matrix will be described. First, a model shown in the following Formula (13) in accordance with the causal order obtained above is considered.

$$[ Math . 31 ]$$

$${v}_{i} = {\sum }_{k ( j ) < k ( i )} {b}_{ij} {v}_{j} + {e}_{i} \qquad Formula ( 13 )$$

This is a model in which a certain variable vᵢ is regressed by all variables having a smaller causal order than that of the variable vi. That is, it is sufficient to obtain a partial regression coefficient when the above Formula (13) is regarded as a linear regression model. Here, a type of sparse regression referred to as adaptive Lasso is used. Specifically, the causal search unit 203 obtains the partial regression coefficient by solving an optimization problem shown in the following Formula (14).

$$[ Math . 32 ]$$

$${b}_{ij} = {arg min}_{{b}_{ij}} ( {‖ {v}_{i} - {\sum }_{k ( j ) < k ( i )} {b}_{ij} {ν}_{j} ‖}^{2} + λ {\sum }_{k ( j ) < k ( i )} \frac{{b}_{ij}}{{\vert \text{?} \vert}^{γ}} ) \qquad Formula ( 14 )$$

Here, λ and γ in Formula (14) represent adjustment parameters.

$$[ Math . 33 ]$$

$$\text{?}$$

[Math. 33] in Formula (14) indicates a consistent estimator estimated using linear regression by a least squares method of bᵢⱼ. The values λ and γ are arbitrarily determined by an operation subject of the apparatus.

By applying a bootstrap method to the above-described step, the causal search unit 203 evaluates the statistical reliability of the obtained coefficient matrix. Specifically, the causal search unit 203 calculates the probability that bᵢ≠0 for N samplings. The causal search unit 203 sets a matrix shown in [Math. 34] as a matrix having a probability value qᵢⱼ in a component (i, j).

$$[ Math . 34 ]$$

$$Q$$

The causal search unit 203 obtains explanatory variables zⱼ (=v₁, . . . , vₘ) whose bootstrap probability for an objective variable y (=v₀) is equal to or greater than c by a step shown in the following Formula (15).

Z^{c}={zⱼ|q₀ⱼ>c, j=1, . . . ,m}. Formula (15)

A reference probability c in Formula (15) is arbitrarily determined by the operation subject of the apparatus.

The causal search unit 203 sets a node set V={v₀, v₁, . . . , vₘ} for the causal relationship storage unit 101, and outputs a causal graph shown in [Math. 36] in which an adjacent matrix between nodes is a coefficient matrix shown in [Math. 35], and a bootstrap probability matrix shown in [Math. 37].

$$[ Math . 35 ]$$

$$B$$

$$[ Math . 36 ]$$

$$G = ( V , B )$$

$$[ Math . 37 ]$$

$$Q$$

In addition, the causal search unit 203 sets the condition related to a function system of a causal search method, the condition related to an error distribution, the condition related to circularity, the condition related to a hidden common cause, the adjustment parameters λ and γ, and the reference probability c as search conditions C^{D}, outputs the search conditions C^{D} to the system condition storage unit 104, and outputs an objective variable y and an explanatory variable group Z^{c} to the learning unit 204.

Next, a step of processing in the learning unit 204 will be described (S103 in FIG. 2B). The learning unit 204 receives the objective variable y and the explanatory variable group Z^{c} from the causal search unit 203, and calculates parameters for predicting the objective variable y from the explanatory variable group Z^{c}.

Here, a model structure to be adopted is shown in [Math. 38].

$$[ Math . 38 ]$$

$$ℳ$$

Here, a linear regression model shown in [Math. 39] is used.

$$[ Math . 39 ]$$

$$ℳ$$

However, as long as the parameters for predicting the objective variable y can be calculated from the explanatory variable group Z^{c}, the model is not limited to the linear regression model.

First, a model represented by the following Formula (16) is considered.

$$[ Math . 40 ]$$

$$y = {θ}_{0} + {\sum }_{{z}_{j} ∈ {Z}^{c}} {θ}_{j} {z}_{j} + e \qquad Formula ( 16 )$$

$$[ Math . 41 ]$$

$$Θ = {( {θ}_{0} , … , {θ}_{\vert {Z}^{c} \vert} )}^{T} , X = ( 1 , {z}_{1} , … , {z}_{\vert {Z}^{c} \vert} )$$

Then, in the case of [Math. 41], the following Formula (17) is established.

$$y = {X}^{T} θ + e \qquad Formula ( 17 )$$

Then, an optimization method adopted for parameter estimation is shown in [Math. 42].

$$[ Math . 42 ]$$

$$𝒪$$

Here, a least squares method shown in [Math. 43] is used.

$$[ Math . 43 ]$$

$$𝒪$$

However, as long as optimal parameters can be obtained, means for estimating parameters is not limited to the least squares method. By applying the least squares method, an optimum parameter @ represented by the following Formula (18) is obtained.

$$Θ = {( {XX}^{T} )}^{- 1} Xy \qquad Formula ( 18 )$$

The learning unit 204 outputs a model structure shown in [Math. 44] and the learned parameter Θ to the learning model storage unit 102.

$$[ Math . 44 ]$$

$$ℳ$$

In addition, the learning unit 204 sets a model structure shown in [Math. 45], an explanatory variable Z^{c}, and a parameter optimization method shown in [Math. 46] as learning conditions C^{L}, and outputs the learning conditions C^{L} to the system condition storage unit 104.

$$[ Math . 45 ]$$

$$ℳ$$

$$[ Math . 46 ]$$

$$𝒪$$

### (2) Contents of Specific Processing During Explanation

Next, a step of processing in the data storage unit 100 during explanation will be described (S200 in FIG. 3B). The data storage unit 100 receives an input of new data from the operation subject of the apparatus and stores it.

Next, a step of processing in the prediction unit 301 will be described (S201 in FIG. 3B). The prediction unit 301 calculates a prediction value shown in [Math. 48] for the input data of the operation subject of the apparatus based on the model structure shown in [Math. 47] and the learned parameter @ received from the learning model storage unit 102.

$$[ Math . 47 ]$$

$$ℳ$$

$$[ Math . 48 ]$$

$$\hat{y}$$

The prediction unit 301 obtains [Math. 49] as shown in the following Formula (19) by assuming the input data to be xᵢₙₚᵤₜ.

$$[ Math . 49 ]$$

$$\hat{y}$$

$$[ Math . 50 ]$$

$$\hat{y} = Θ {x}_{input} \qquad Formula ( 19 )$$

The prediction unit 301 outputs the input data xᵢₙₚᵤₜ, a model structure shown in [Math. 51], and a prediction value shown in [Math. 52] to the presentation unit 302.

$$[ Math . 51 ]$$

$$ℳ$$

$$[ Math . 52 ]$$

$$\hat{y}$$

Next, a step of processing in the presentation unit 302 will be described (S202 in FIG. 3B). The presentation unit 302 presents a prediction value shown in [Math. 53] and received from the prediction unit 301 to the operation subject of the apparatus as a prediction result.

$$[ Math . 53 ]$$

$$\hat{y}$$

In addition, the presentation unit 302 presents the input data xᵢₙₚᵤₜ received from the prediction unit 301 to the operation subject of the apparatus as history data of the operation subject of the apparatus. In addition, the presentation unit 302 receives the search conditions C^{D} and the learning conditions C^{L} from the system condition storage unit 104, and presents these to the operation subject of the apparatus as auxiliary information for explaining that a prediction value has been obtained. Further, the presentation unit 302 receives a causal graph shown in [Math. 54] and a bootstrap probability matrix shown in [Math. 55] from the causal relationship storage unit 101, and presents a subgraph G′⊂G of a causal graph G consisting of a coefficient bᵢⱼ between a node v∈{y}∩Z^{c} and a node v to the operation subject of the apparatus.

$$[ Math . 54 ]$$

$$G = ( V , B )$$

$$[ Math . 55 ]$$

$$Q$$

An example of presentation of a part of these pieces of information is shown in an upper portion of the example of the interface shown in FIG. 3C. Here, it is assumed that, when input data (sign “c” in FIG. 3C) related to lifestyle habits during the past month's diet period is given, a rebound rate for the following month is predicted, and a prediction result is explained to the operation subject of the apparatus through the screen G1.

In the example shown in FIG. 3C, it is assumed that a causal search method and a machine learning method displayed in a column of information regarding a method for prediction (signs “d” and “e” in FIG. 3C) are displayed in a drop-down form so that they can be selected by the operation subject of the apparatus.

When an update button on the screen is selected, (1) the causal graph (sign “a” in FIG. 3C) and (2) the prediction value (sign “b” in FIG. 3C) are updated in accordance with a condition selected in the drop-down manner by the operation subject of the apparatus. Details of this step will be described later in a step of processing in the adjustment unit 402 (S303 in FIG. 4B).

### (3) Contents of Specific Processing During Evaluation

Next, a step of processing in the evaluation unit 401 will be described (S300 in FIG. 4B). The evaluation unit 401 receives, as inputs, a prediction result obtained by the apparatus and an evaluation value for interpretability of the explanation from the operation subject of the apparatus.

Here, regarding an evaluation item for the interpretability, when a prediction result presented by the apparatus, a cause, a history of calculation thereof, an action of a model, and other information associated with the explanation of the prediction result are read by the operation subject of the apparatus, a question form and an answer form may be arbitrary as long as subjective evaluation of the operation subject of the apparatus for presentation information of the system from the viewpoint of interpretability is measured, such as whether they are easy to understand, convincing, and trustworthy.

Here, as an example, as described in an interface (sign “a” in FIG. 4D) of the evaluation unit 401 in an example of an interface shown in FIG. 4D, the degree of understanding of the cause of a prediction result is inquired in three stages, and an answer result is received as an evaluation value for interpretability of the operation subject of the apparatus.

The (set of) evaluation values related to interpretability input by the operation subject of the apparatus is defined as R in the evaluation unit 401. The evaluation unit 401 outputs the evaluation value set R to the evaluation value storage unit 103.

Next, a step of processing in the evaluation value storage unit 103 will be described (S301 in FIG. 4B). The evaluation value storage unit 103 receives the evaluation value set R output in S300 from the evaluation unit 401 and stores it in the evaluation value storage unit 103. In addition, the evaluation value storage unit 103 receives the evaluation value set R output in S300 from the evaluation unit 401 and outputs it to the system condition storage unit 104.

Next, a step of processing in the system condition storage unit 104 will be described (S302 in FIG. 4B). The system condition storage unit 104 receives the evaluation value set R from the evaluation value storage unit 103, and stores search conditions C^{D} received from the causal search unit 203 during learning and the learning conditions C^{L} received from the learning unit 204 during learning in association with each other as <R, C^{D}, C^{L}>.

Next, a step of processing in the adjustment unit 402 will be described (S303 in FIG. 4B). The adjustment unit 402 is intended to present a new prediction result after the operation subject of the apparatus adjusts the prediction result obtained by the apparatus, and the search conditions C^{D} and the learning conditions C^{L} (models and parameters of the causal search method and machine learning method) which are used in the process of generating the explanation, receives new models and parameters as inputs from the operation subject of the apparatus via the interface (sign “b” in FIG. 4D), sets these as a new search condition shown in [Math. 56] and learning condition shown in [Math. 57], and outputs a search condition shown in [Math. 58] to the causal search unit 203 and a learning condition shown in [Math. 59] to the learning unit 204.

$$[ Math . 56 ]$$

$${\dot{C}}^{D}$$

$$[ Math . 57 ]$$

$${\dot{C}}^{L}$$

$$[ Math . 58 ]$$

$${\dot{C}}^{D}$$

$$[ Math . 59 ]$$

$${\dot{C}}^{L}$$

Here, as an example, a case in which the reference probability c=0.50 adopted by the causal search unit 203 during learning is updated to 0.30 will be described. It is assumed that there is no change in the learning condition.

Next, processing in the causal search unit 203 (S304 in FIG. 4B) will be described. This processing is the same as the processing during learning (S102) after the search condition is updated to that shown in [Math. 60] by the causal search unit 203.

$$[ Math . 60 ]$$

$${\dot{C}}^{D}$$

Here, since the search condition is updated to that shown in [Math. 61], that is, the reference probability is updated from c=0.50 to 0.30, an explanatory variable group is updated as shown in [Math. 62].

$${\dot{C}}^{D} \qquad [ Math . 61 ]$$

$${Z}^{c} \to {\dot{Z}}^{c} \qquad [ Math . 62 ]$$

The causal search unit 203 outputs a search condition shown in [Math. 63] to the system condition storage unit 104, and outputs [Math. 64] to the learning unit 204.

$${\dot{C}}^{D} \qquad [ Math . 63 ]$$

$${\dot{Z}}^{c} \qquad [ Math . 64 ]$$

Next, processing in the learning unit 204 (S305 in FIG. 4B) will be described. This processing is the same as the processing during learning (S103) after the learning unit 204 receives an updated explanatory variable group shown in [Math. 65] from the causal search unit 203 and the explanatory variable group is changed to that shown in [Math. 66].

$${\dot{Z}}^{c} \qquad [ Math . 65 ]$$

$${\dot{Z}}^{c} \qquad [ Math . 66 ]$$

Thereby, a learned parameter is updated as shown in [Math. 67].

$$Θ \to \dot{Θ} \qquad [ Math . 67 ]$$

The learning unit 204 outputs the updated learning parameter shown in [Math. 68] to the learning model storage unit 102.

$$\dot{Θ} \qquad [ Math . 68 ]$$

Next, processing (S306 in FIG. 4C) in the prediction unit 301 will be described. This process is the same as the processing during explanation (S201) after the prediction unit 301 receives the updated learning parameter shown in [Math. 69] from the learning unit 204 and the updated learning parameter is changed to that shown in [Math. 70].

$$\dot{Θ} \qquad [ Math . 69 ]$$

$$\dot{Θ} \qquad [ Math . 70 ]$$

Thereby, a prediction value is updated as shown in [Math. 71].

$$y \to \dot{y} \qquad [ Math . 71 ]$$

The prediction unit 301 outputs the updated prediction value shown in [Math. 72] to the presentation unit 302.

$$\dot{y} \qquad [ Math . 72 ]$$

Next, processing in the presentation unit 302 will be described (S307 in FIG. 4C). In this processing, the presentation unit 302 receives an updated prediction value shown in [Math. 73] from the prediction unit 301, changes the prediction value as shown in [Math. 74], and presents the updated prediction value shown in [Math. 75] to the operation subject of the apparatus.

$$\dot{y} \qquad [ Math . 73 ]$$

$$\dot{y} \qquad [ Math . 74 ]$$

$$\dot{y} \qquad [ Math . 75 ]$$

Furthermore, the presentation unit 302 receives a causal graph shown in [Math. 76] and a bootstrap probability matrix shown in [Math. 77] from the causal relationship storage unit 101, and presents a subgraph G′⊂G of the causal graph G consisting of a coefficient bᵢⱼ between a node shown in [Math. 78] and a node v to the operation subject of the apparatus.

$$G = ( V , B ) \qquad [ Math . 76 ]$$

$$Q \qquad [ Math . 77 ]$$

$$v ∈ \{ y \} ⋂ {\dot{Z}}^{c} \qquad [ Math . 78 ]$$

### (4) Contents of Specific Processing During Updating

Next, processing in the setting unit 501 during updating will be described (S400 in FIG. 5B). The setting unit 501 is started up at an arbitrary timing in response to an instruction given by the operation subject of the apparatus. For example, there is a method of explicitly giving an instruction and periodically giving an instruction of start-up.

The processing performed by the setting unit 501 is intended to set a search condition and a learning condition that are estimated to be most interpretable for the operation subject of the apparatus in the causal search unit 203 and the learning unit 204, respectively, by using information on the search conditions, the learning conditions, and the evaluation value sets stored in the system condition storage unit 104.

In the system condition storage unit 104, a certain search condition C^{D}, a certain learning condition C^{L}, and a certain evaluation value set R corresponding thereto are stored as <R, C^{D}, C^{L}>, which are taken as one unit of information. Hereinafter, an i-th recorded <R, C^{D}, C^{L}> is taken as a condition evaluation unit shown in [Math. 79] (the i-th record is earlier than an (i+1)-th record).

$${u}_{i} = < {R}_{i} , {C}_{i}^{D} , {C}_{i}^{L} > , i ∈ \{ 1 , … , N \} \qquad [ Math . 79 ]$$

First, the setting unit 501 receives a condition evaluation unit u; from the system condition storage unit 104. Here, the setting unit 501 may receive all condition evaluation units stored in the system condition storage unit 104. In addition, the setting unit 501 may receive some of all of the condition evaluation units stored in the system condition storage unit 104.

For example, there is a method in which the setting unit 501 receives condition evaluation units recorded during the latest one week, and receives condition evaluation units obtained by randomly extracting 50% of the whole. Here, the subsequent processing will be described on the assumption that the setting unit 501 has received all of the condition evaluation units.

The setting unit 501 extracts, from all of the condition evaluation units uᵢ received from the system condition storage unit 104, the following condition evaluation unit, which is shown in [Math. 80] and [Math. 81], having the highest evaluation value of interpretability and having been recorded most recently.

$${u}_{i}^{*} \qquad [ Math . 80 ]$$

$${u}_{i}^{*} = < {R}_{i}^{*} , {C}_{{i}^{*}}^{D} , {C}_{{i}^{*}}^{L} , > \qquad [ Math . 81 ]$$

$${R}_{i}^{*} \geq {R}_{i}^{*} , {i}^{*} > i ; {i}^{*} , i ∈ ( 1 , … , N \} ( {i}^{*} \neq i )$$

The setting unit 501 outputs [Math. 82] to the causal search unit 203, and outputs [Math. 83] to the learning unit 204.

$${C}_{{i}^{*}}^{D} \qquad [ Math . 82 ]$$

$${C}_{{i}^{*}}^{L} \qquad [ Math . 83 ]$$

In the above, the extraction condition is that the evaluation value of interpretability is highest and it has been recorded most recently, but as long as it is possible to achieve the purpose of setting a search condition and a learning condition that are estimated to be the most interpretable for the operation subject of the apparatus in the causal search unit 203 and the learning unit 204 by the setting unit 501, a method of extracting a condition evaluation unit is not limited to the above. For example, there is a method of selecting a search condition and a learning condition having the highest evaluation value of interpretability and the highest use frequency among them.

Next, processing in the causal search unit 203 will be described (S401 in FIG. 5B). The causal search unit 203 receives [Math. 84] from the setting unit 501, and updates the causal search condition of the causal search unit 203 as shown in [Math. 85].

$${C}_{{i}^{*}}^{D} \qquad [ Math . 84 ]$$

$${C}^{D} \to {C}_{{i}^{*}}^{D} \qquad [ Math . 85 ]$$

Next, processing in the learning unit 204 during updating will be described (S402 in FIG. 5B). The learning unit 204 receives [Math. 86] from the setting unit 501, and updates the learning condition of the learning unit 204 as shown in [Math. 87].

$${C}_{{i}^{*}}^{L} \qquad [ Math . 86 ]$$

$${C}^{L} \to {C}_{{i}^{*}}^{L} \qquad [ Math . 87 ]$$

### Effects of Present Embodiment

In this embodiment, it is possible to evaluate whether a causal relationship between variables obtained using a statistical causal search method can be understood by a person who is an operation subject of the apparatus, in association with conditions of a model.

In this embodiment, setting conditions of the system which are preferable or not preferable for the operation subject of the apparatus can be grasped.

From the above two points, in this embodiment, since the interpretability of information presentation using a machine learning model can be enhanced from the viewpoint of a human being, it is possible to construct a prediction model of a variable to be predicted which is easy to understand by a user.

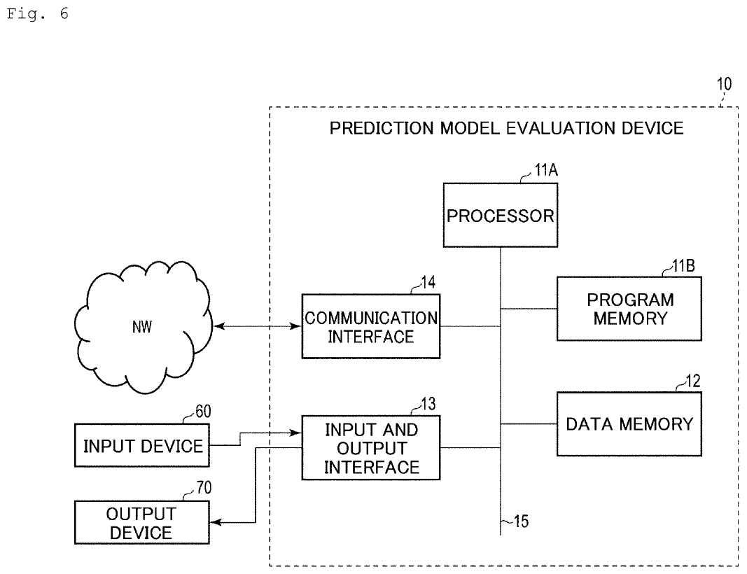

FIG. 6 is a block diagram showing an example of a hardware configuration of a prediction model evaluation apparatus according to an embodiment of the present invention.

In the example shown in FIG. 6, a prediction model evaluation apparatus 10 according to the above-described embodiment is constituted by, for example, a server computer or a personal computer, and includes a hardware processor 11A such as a CPU. In addition, a program memory 11B, a data memory 12, an input and output interface 13, and a communication interface 14 are connected to the hardware processor 11A via a bus 15.

The communication interface 14 includes one or more wireless communication interface units, for example, and enables transmission and reception of information to and from a communication network NW. As the wireless interface, an interface that adopts a low power wireless data communication standard such as a wireless LAN (Local Area Network) can be used, for example.

An input device 60 and an output device 70 attached to the prediction model evaluation apparatus 10 used by a user or the like are connected to the input and output interface 13.

The input and output interface 13 receives operation data input by the user or the like through the input device 60 such as a keyboard, a touch panel, a touchpad, a mouse, or the like, and performs processing of outputting and displaying output data to the output device 70 including a display device using a liquid crystal, an organic electro luminescence (EL), or the like. As the input device 60 and the output device 70, devices built in the prediction model evaluation apparatus 10 may be used, or an input device and an output device of another information terminal capable of communicating with the prediction model evaluation apparatus 10 via a network NW may be used.

The program memory 11B is a combination of a non-volatile memory capable of writing and reading at any time such as a hard disk drive (HDD) or a solid state drive (SSD) and a non-volatile memory such as a read only memory (ROM) as a non-transitory and tangible storage medium, and stores programs necessary for executing various types of control processing and the like according to one embodiment.

The data memory 12 is combination of the above-described non-volatile memory and a volatile memory such as a random access memory (RAM) as a tangible storage medium, and is used to store various types of data acquired and created as various types of processing are performed.

The prediction model evaluation apparatus 10 according to one embodiment of the present invention may be configured as a data processing apparatus including processing function units using software.

Various storage units used as work memories by the prediction model evaluation apparatus 10 can be configured using the data memory 12 shown in FIG. 6. However, these configured storage regions are not essential configurations in the prediction model evaluation apparatus 10, and may be, for example, regions provided in an external storage medium such as a universal serial bus (USB) memory, or in a storage device such as a database server disposed in the cloud.

The above-described processing function units can be implemented by causing the hardware processor 11A to read and execute a program stored in the program memory 11B. Some or all of these processing function units may be implemented in a variety of other forms, including integrated circuits such as an application-specific integrated circuit (ASIC) or a field-programmable gate array (FPGA).

In addition, the method described in each embodiment may be stored, as a program (software means) that can be executed by a computer, for example, in a recording medium such as a magnetic disk (a Floppy (registered trademark) disk, a hard disk, or the like), an optical disc (a CD-ROM, a DVD, an MO, or the like), or a semiconductor memory (a ROM, a RAM, a flash memory, or the like), or transmitted and distributed via a communication medium. The program stored in the medium side includes a setting program for configuring software means (including not only execution programs but also tables and data structures) in the computer to be executed by the computer. The computer realizing the present device reads the program recorded on the recording medium, and if necessary, constructs the software means using the setting program, and executes the above-described processing by having its operations controlled by the software means. The recording medium referred to herein is not limited to a recording medium for distribution, and includes a storage medium such as a magnetic disk or a semiconductor memory provided inside the computer or in a device connected via a network.

The present invention is not limited to the above-described embodiment and can be modified in various forms without departing from the gist of the present invention at an implementation stage. In addition, the embodiments may be combined as appropriate. In this case, combined effects can be achieved. Further, the above-described embodiments include various aspects of the invention, and the various aspects of the invention can be extracted by combinations selected from a plurality of disclosed constituent elements. For example, even when some of all the constituent elements disclosed in the embodiments are deleted, a configuration from which the constituent elements are deleted can be extracted as an aspect of the invention as long as the problems can be solved and the effects can be obtained.

### REFERENCE SIGNS LIST

10 Prediction model evaluation apparatus
100 Data storage unit
101 Causal relationship storage unit
102 Learning model storage unit
103 Evaluation value storage unit
104 System condition storage unit
200 Learning mechanism
201 Preprocessing unit
202 Correlation detection unit
203 Causal search unit
204 Learning unit
300 Explanation mechanism
301 Prediction unit
5 302 Presentation unit
400 Evaluation mechanism
401 Evaluation unit
402 Adjustment unit
500 Updating unit
501 Setting unit

1. A prediction model evaluation apparatus comprising:
a circuitry configured to:
search for a causal relationship between observation data of a variable to be predicted and observation data of an explanatory variable significantly correlated with the variable to be predicted, and obtain an explanatory variable having a parent relationship with the variable to be predicted based on the searched causal relationship;
generate a prediction model for predicting the variable to be predicted from the explanatory variable;
calculate a prediction value significantly correlated with input data by using the generated prediction model;
receive an input of a new condition for searching for the causal relationship and a new condition for generating the prediction model;
newly search for a causal relationship between the variable to be predicted and the explanatory variable significantly correlated with the variable to be predicted based on the new condition for searching;
newly obtain an explanatory variable having a parent relationship with the variable to be predicted based on the newly searched causal relationship;
newly generate a prediction model for predicting the newly obtained explanatory variable having a parent relationship with the variable to be predicted based on the new condition for generating; and
newly calculate the prediction value by using the newly generated prediction model.

2. The prediction model evaluation apparatus according to claim 1, the circuitry is further configured to:
perform preprocessing for normalizing the explanatory variable by excluding a deficit value of the observation data to be predicted and a deficit value of the observation data of the explanatory variable; and
search for a causal relationship between the observation data of the variable to be predicted and the observation data of the explanatory variable which is significantly correlated with the variable to be predicted and has been preprocessed.

3. The prediction model evaluation apparatus according to claim 1, the circuitry is further configured to:
output a condition for searching for the causal relationship, a condition for generating the prediction model, and the searched causal relationship; and
receive an input of an evaluation result for the prediction value and an input of an evaluation result for the output result.

4. The prediction model evaluation apparatus according to claim 3, wherein the circuitry is configured to:
calculate a prediction value for each of a plurality of pieces of the input data,
receive an input of an evaluation result for each of the predicted prediction values; and
set a structure of the prediction model when the evaluation result is optimal and an output condition when the evaluation result is optimal based on the evaluation result and the output conditions.

5. A method performed by a prediction model evaluation apparatus, the method comprising:
searching for a causal relationship between observation data of a variable to be predicted and observation data of an explanatory variable significantly correlated with the variable to be predicted, and obtaining an explanatory variable having a parent relationship with the variable to be predicted based on the searched causal relationship;
generating a prediction model for predicting the variable to be predicted from the explanatory variable;
calculating a prediction value significantly correlated with input data by using the generated prediction model;
receiving an input of a new condition for searching for the causal relationship and a new condition for generating the prediction model;
newly searching for a causal relationship between the variable to be predicted and the explanatory variable significantly correlated with the variable to be predicted based on the new condition for searching;
newly obtaining an explanatory variable having a parent relationship with the variable to be predicted based on the newly searched causal relationship;
newly generating a prediction model for predicting the newly obtained explanatory variable having a parent relationship with the variable to be predicted based on the new condition for generating; and
newly calculating the prediction value by using the newly generated prediction model.

6. A non-transitory storage medium storing a prediction model evaluation processing program for causing a computer to execute:
searching for a causal relationship between observation data of a variable to be predicted and observation data of an explanatory variable significantly correlated with the variable to be predicted, and obtaining an explanatory variable having a parent relationship with the variable to be predicted based on the searched causal relationship;
generating a prediction model for predicting the variable to be predicted from the explanatory variable: calculating a prediction value significantly correlated with input data by using the generated prediction model; receiving an input of a new condition for searching for the causal relationship and a new condition for generating the prediction model:
newly searching for a causal relationship between the variable to be predicted and the explanatory variable significantly correlated with the variable to be predicted based on the new condition for searching;
newly obtaining an explanatory variable having a parent relationship with the variable to be predicted based on the newly searched causal relationship;
newly generating a prediction model for predicting the newly obtained explanatory variable having a parent relationship with the variable to be predicted based on the new condition for generating; and
newly calculating the prediction value by using the newly generated prediction model.
